(19) United States
(12) Patent Application Publication
(10) Pub. No.: US 2011/0113564 A1
(43) Pub. Date: May 19, 2011

(54) Wire-Stripping Tool

(76) Inventors: Chien-Chou Liao, Tu Cheng City (TW); Chien-Hung Chou, Tu Cheng City (TW)

(21) Appl. No.: 12/721,719

(22) Filed: Mar. 11, 2010

(30) Foreign Application Priority Data
Nov. 16, 2009 (TW) 098221269

(51) Int. Cl. H01R 43/05; H02G 1/12

(52) U.S. Cl. 7/107; 30/90.1

(57) ABSTRACT

A wire-stripping tool allowing the user to strip-off the outer insulation layer of a wire is disclosed. The wire-stripping tool comprises a first shaft and a second shaft. The first shaft comprises a first cone-shaped blade and a first handle. The second shaft is pivotally connected with the first shaft, and the second shaft comprises a second cone-shaped blade and a second handle. The second cone-shaped blade can be overlapped with the first cone-shaped blade to form a cutting blade; the first handle and the second handle allow the user to exert a force. The wire-stripping tool has an open-state and a closed-state: In an open-state, the wire can be inserted into the cutting blade; in a closed-state, the user can apply a force onto the first and the second handles, and then the cutting blade can cut off the outer insulation layer.

### BACKGROUND OF THE INVENTION

1. Field of the Invention

The present invention relates to a wire-stripping tool; more particularly, it relates to a wire-stripping tool which is able to remove the outer insulation layer of a wire.

2. Description of the Related Art

Refer to FIG. 1 and FIG. 2, which shows the wire-stripping pliers of the prior art. In the prior art, the thicknesses (the sharpness) of blade 80 and blade 80a of the wire-stripping pliers are not consistent. When the outer insulation layer of the wire is to be removed using this type of wire-stripping pliers consisting of inconsistent blade 80 and blade 80a thicknesses, resistance will usually be encountered during the rotary-cut. This is especially true when stripping the outer insulation layer of a thick wire, as the process will be unsmooth during the rotary cut.

Therefore, it is necessary to provide a wire-stripping tool with consistent blade thickness to resolve the aforementioned problem.

### SUMMARY OF THE INVENTION

The object of the present invention is to provide a wire-stripping tool to remove the outer insulation layer of a wire.

To achieve the above mentioned objective, the wire-stripping tool of the present invention comprises a first shaft and a second shaft. The first shaft comprises a first cone-shaped blade and a first handle; the second shaft is pivotally connected with the first shaft, and the second shaft comprises a second cone-shaped blade and a second handle. The second cone-shaped blade can be overlapped with the first cone-shaped blade to form a cutting blade. The first handle and the second handle allow the user to exert a force. The wire-stripping tool has an open-state and a closed-state: in the open-state, the wire can be inserted into the cutting blade; in the closed-state, the user can apply force onto the first and second handles, and then the cutting blade can cut off the outer insulation layer.

The present invention is innovative and provides a substantial improvement; therefore, a new patent is filed.

### BRIEF DESCRIPTION OF THE DRAWINGS

FIG. 1 and FIG. 2 show the wire-stripping pliers of the prior art.

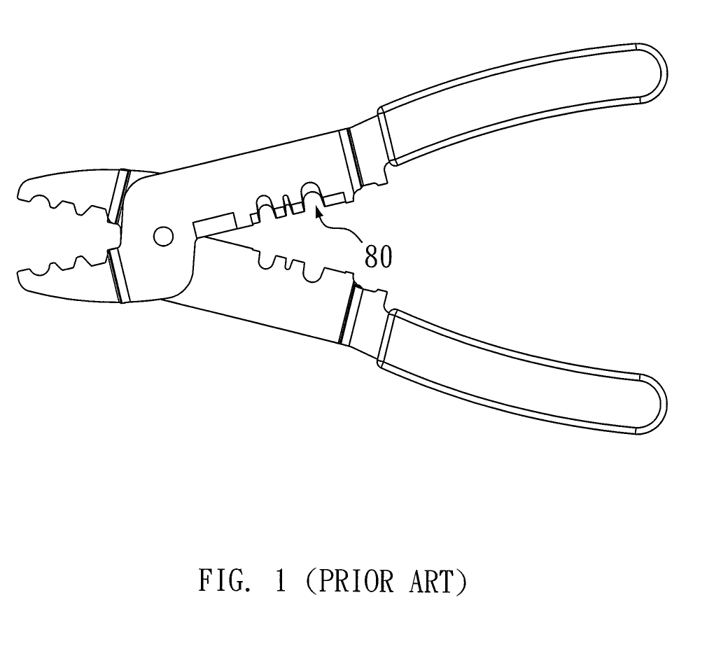

FIG. 3 is a 3-D view of the wire-stripping tool in an open-state.

FIG. 4 is a top view of the wire-stripping tool in a closed-state.

FIG. 4A shows the relative positions of the cutting blade and the wire of the wire-stripping tool during a closed-state.

FIG. 5 is a 3D view of the wire-stripping tool in an open-state.

FIG. 6 is a top view of the wire-stripping tool in a closed-state.

FIG. 6A shows the relative positions of the cutting blade and the wire of the wire-stripping tool during a closed-state.

### DETAILED DESCRIPTION OF THE PREFERRED EMBODIMENT

The advantages and innovative features of the invention will become more apparent from the following preferred embodiments.

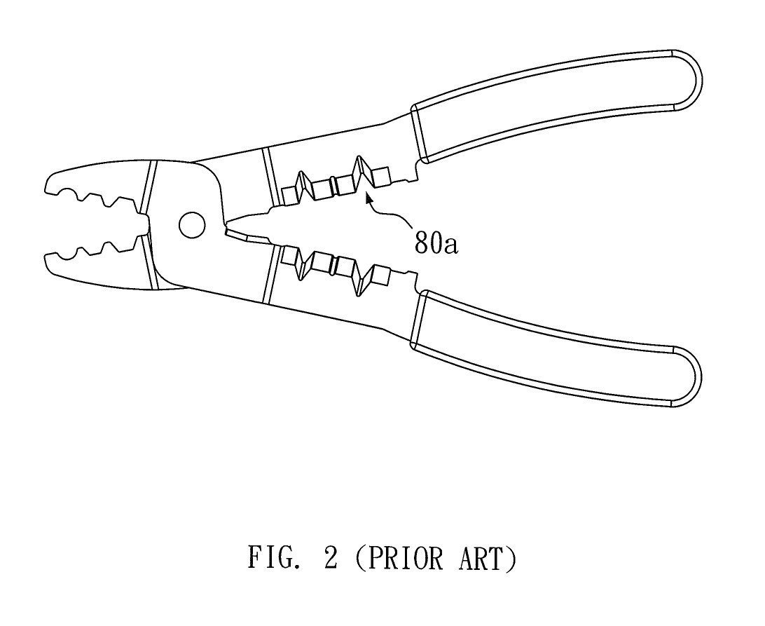

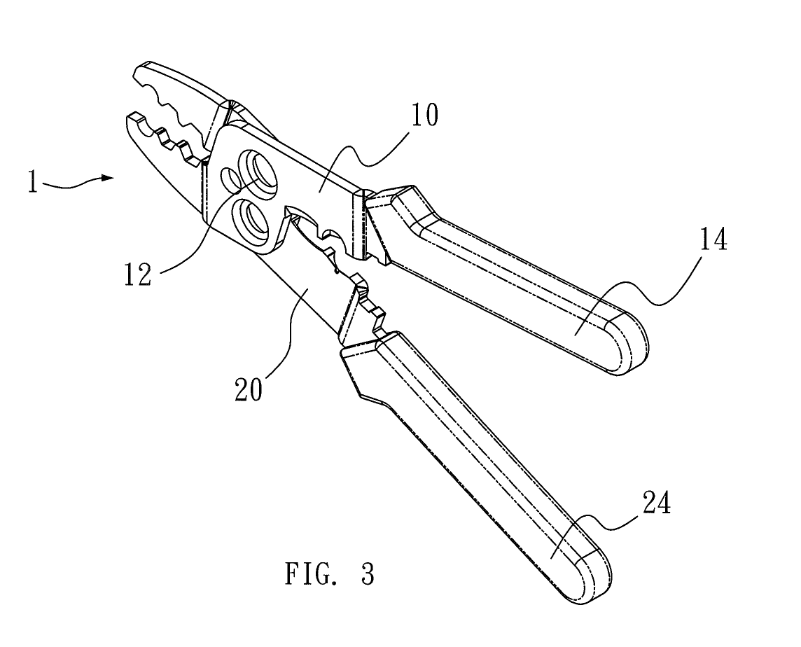

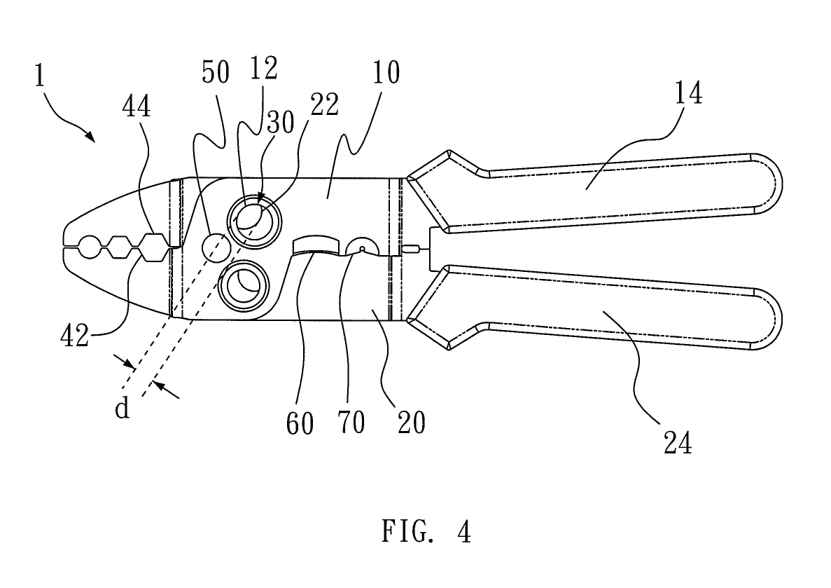

Refer to FIG. 3, FIG. 4, and FIG. 4A for the first embodiment of the wire-stripping tool of the present invention. FIG. 3 is a 3-D view of the wire-stripping tool in an open-state. FIG. 4 is a top view of the wire-stripping tool in a closed-state. FIG. 4A shows the relative position of the cutting blade and the wire of the wire-stripping tool during a closed-state.

A wire-stripping tool 1 of the present invention allows the user to strip-off the outer insulation layer of a wire 90. For example, the wire 90 can be a power cable or a coaxial cable.

The wire-stripping tool 1 comprises a first shaft 10 and a second shaft 20. The first shaft 10 comprises a first cone-shaped blade 12 and a first handle 14. The second shaft 20 is pivotally connected with first shaft 10 (at pivot point 50, as shown in FIG. 4), and the second shaft 20 comprises a second cone-shaped blade 22 and a second handle 24; the first handle and the second handle allow the user to exert force.

In the present invention, the first cone-shaped blade 12 and the second cone-shaped blade 22 are both circular. The first cone-shaped blade 12 and the second cone-shaped blade 22 are both slanted. A cutting blade 30 is formed by overlapping the second cone-shaped blade 22 with the first cone-shaped blade 12 for cutting the wire 90. In other words, the cutting blade 30 is constituted by a portion of the first cone-shaped blade 12 and a portion of the second cone-shaped blade 22. The sharpness of cutting blade 30 is essentially the same in every perspective. Furthermore, the first cone-shaped blade 12 and the second cone-shaped blade 22 are both circular, so the first cone-shaped blade 12 and the second cone-shaped blade 22 can be easily manufactured.

The wire-stripping tool 1 has an open-state and a closed-state, both of which will be described in the subsequent section.

(1) Open-State (as Shown in FIG. 3);

During the open-state, the wire 90 can be inserted into the cutting blade 30. In the present embodiment, the first cone-shaped blade 12 and the second cone-shaped blade 22 overlap to form a circular cutting blade 30. The diameter of the circle is greater than the diameter of the wire 90 so that the wire 90 can be inserted into the cutting blade 30. Please note that in the open-state, the shape of the cutting blade 90 is not limited to the abovementioned configuration. During the open-state, the cutting blade 30 can be any shape, as long as the wire 90 can pass through the narrowest section.

(2) Closed-State (as Shown in FIG. 4 and FIG. 4A);

During the closed-state, the user can apply force onto the first handle 14 and the second handle 24, and then the cutting blade 30 can cut off the outer insulation layer. During the closed-state, the first cone-shaped blade 12 and the second cone-shaped blade 22 overlap to form an eye-shaped cutting blade 30, as shown in FIG. 4.

The cutting blade 30 comprises an interior cutting diameter d; the cutting diameter d must be smaller than the diameter of the wire 90 (as shown in FIG. 4A; the wire 90 is shown with the dotted line) in order to cut the wire 90 with the cutting blade 30.

In the closed-state of the present invention, the cutting blade 30 can only cut shallowly into the diameter of the wire 90 (as shown in FIG. 4A); therefore, the cutting blade 30 must carry out rotary-cutting (via rotation of the cutting blade 30 and wire 90 in counter directions) to completely remove the outer insulation layer. The sharpness of cutting blade 30 is essentially the same in every perspective; therefore, the rotary-cutting can be performed smoothly.

Refer to FIG. 4. In order to increase the functionality of the wire-stripping tool 1, the front end of the first shaft 10 of the present embodiment further comprises a first crimping section 42, and the front end of the second shaft 20 further comprises a second crimping section 44. During the closed-state, the first crimping section and the second crimping section form a crimping zone, which is used to join a coaxial terminal with a coaxial cable. For example, the crimping zone can be circular-shaped or hexagonally-shaped.

In order to increase the functionality of the wire-stripping tool 1, the first shaft 10 of the present embodiment further comprises a wire-snapping blade 60 and a conductor-avoiding blade 70 (as shown in FIG. 4). The wire-snapping blade 60 is used to completely sever the wire 90, and the conductor-avoiding blade 70 is used to sever everything apart from the conductor of the wire 90; in other words, the conductor-avoiding blade 70 can cut off the outer insulation layer, the inner insulation layer, and leave the central conductor of the wire 90.

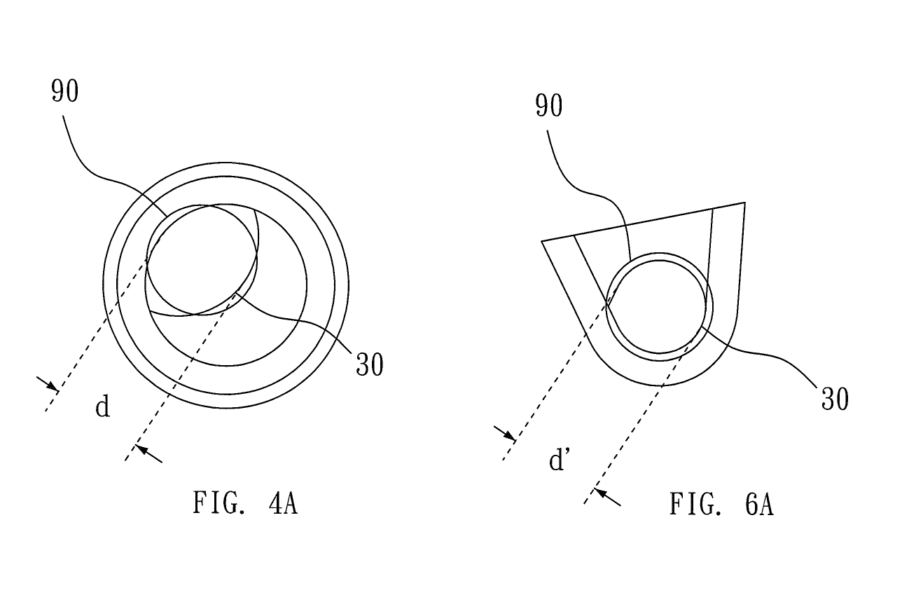

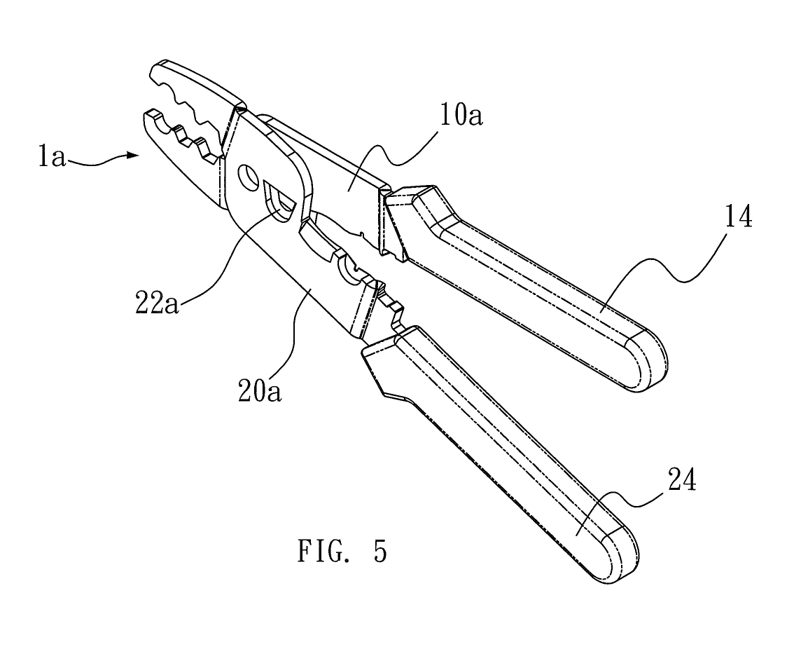

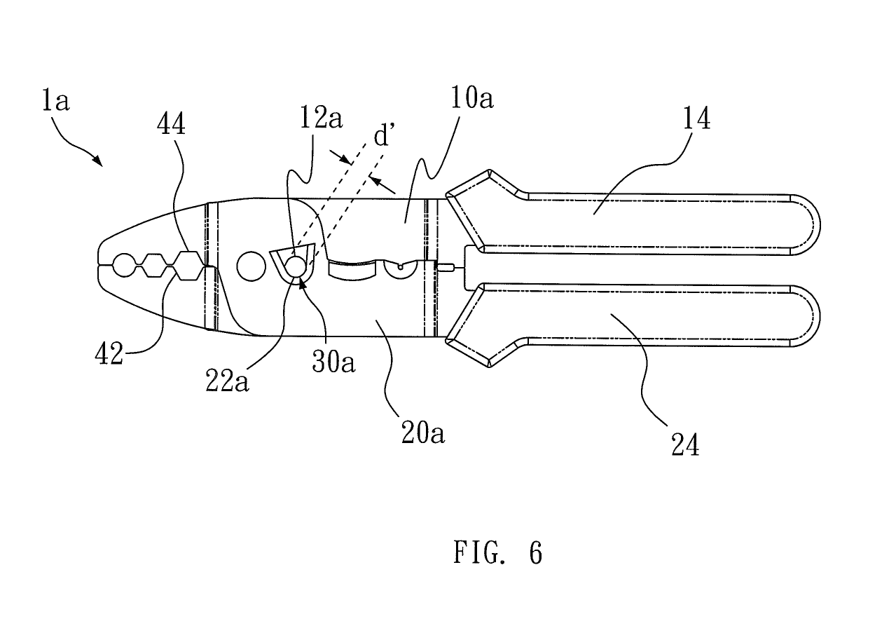

Next, refer to FIG. 5, FIG. 6, and FIG. 6A for the second embodiment of the wire-stripping tool. FIG. 5 is a 3D view of the wire-stripping tool in an open-state. FIG. 6 is a top view of the wire-stripping tool in a closed-state. FIG. 6A shows the relative position of the cutting blade and the wire of the wire-stripping tool during a closed-state.

The wire-stripping tool 1a comprises a first shaft 10a and a second shaft 20a. The first shaft 10a comprises a first cone-shaped blade 12a and a first handle 14a. The second shaft 20a is pivotally connected with first shaft 10a; the second shaft 20a comprises a second cone-shaped blade 22a and a second handle 24a. The second cone-shaped blade 22a and the first cone-shaped blade 12a can be overlapped to form a cutting blade 30a, enabling adjustment of the gap distance.

The difference between this embodiment and the first embodiment lies within the shape of the second cone-shaped blade 22a and the first cone-shaped blade 12a, and within the shape of the cutting blade 30a. In the present embodiment, the blades of the first cone-shaped blade 12a and the second cone-shaped blade 22a are semi-circular in shape. During the closed-state, the cutting blade 30a formed by the overlapping of the second cone-shaped blade 22a with the first cone-shaped blade 12a is essentially circular (as shown in FIG. 6).

The cutting diameter d′ must be smaller than the diameter of the wire 90 (as shown in FIG. 6A, the wire 90 is shown with a dotted line) in order to cut the wire 90 with the cutting blade 30a.

In the closed-state of the present invention, the cutting blade 30a can completely cut off the outer perimeter of the wire 90 (as shown in FIG. 6A); therefore, there is no need for rotary-cutting. The user can directly remove the outer insulation layer of wire 90 by applying force onto the first handle 14 and the second handle 24.

Take note that the shape of the first cone-shaped blade of the first shaft and the second cone-shaped blade of the second shaft are not limited to the aforementioned shapes. Any invention should be covered by the present invention as long as the cutting blade formed by the overlapping of the second cone-shaped blade and the first cone-shaped blade is able to remove the outer insulation layer of a wire.

Although the present invention has been explained in relation to its preferred embodiment, it is also of vital importance to acknowledge that many other possible modifications and variations can be made without departing from the spirit and scope of the invention as hereinafter claimed.

What is claimed is:

1. A wire-stripping tool allowing a user to strip-off an outer insulation layer of a wire, the wire-stripping tool comprising:
a first shaft, the first shaft comprising:
a first cone-shaped blade; and
a first handle; and
a second shaft, the second shaft being pivotally connected with the first shaft, the second shaft comprising:
a second cone-shaped blade; the second cone-shaped blade can be overlapped with the first cone-shaped blade to form a cutting blade; and
a second handle, wherein the first handle and the second handle allow the user to exert a force;
the wire-stripping tool has an open-state and a closed-state:
in the open-state, the wire can be inserted into the cutting blade;
in the closed-state, the user can apply a force onto the first and the second handle, and then the cutting blade can cut off the outer insulation layer.

2. The wire-stripping tool as claimed in claim 1, wherein the first cone-shaped blade and the second cone-shaped blade are both circular.

3. The wire-stripping tool as claimed in claim 2, wherein during the closed-state, the cutting blade removes the outer insulation layer through rotary-cutting.

4. The wire-stripping tool as claimed in claim 1, wherein during the closed-state, the cutting blade is substantially circular.

5. The wire-stripping tool as claimed in claim 4, wherein the first cone-shaped blade and the second cone-shaped blade respectively comprise a semi-circular shaped blade.

6. The wire-stripping tool as claimed in claim 1, wherein the first shaft further comprises a first crimping section, and the second shaft further comprises a second crimping section; during the closed-state, the first crimping section and the second crimping section form a crimping zone.

7. The wire-stripping tool as claimed in claim 6, wherein the crimping zone is circular-shaped or hexagonally-shaped.

8. The wire-stripping tool as claimed in claim 1, wherein the first shaft further comprises a wire-snipping blade.

9. The wire-stripping tool as claimed in claim 1, wherein the first shaft further comprises a conductor-avoiding blade.

10. The wire-stripping tool as claimed in claim 1, wherein the cutting blade comprises an interior cutting diameter, wherein the interior cutting diameter is smaller than the diameter of the wire.

11. The wire-stripping tool as claimed in claim 1, wherein the sharpness of the cutting blade is substantially the same in every perspective.

12. The wire-stripping tool as claimed in claim 1, wherein the wire is a power cable or a coaxial cable.

13. The wire-stripping tool as claimed in claim 6, wherein the first shaft further comprises a wire-snipping blade.

14. The wire-stripping tool as claimed in claim 6, wherein the first shaft further comprises a conductor-avoiding blade.
